(19) United States
(12) Patent Application Publication
(10) Pub. No.: US 2021/0005947 A1
(43) Pub. Date: Jan. 7, 2021

(54) RIDGE GAP WAVEGUIDE SWITCHES AND RECONFIGURABLE POWER SPLITTERS

(71) Applicants: Ahmed Abdelwahed KISHK, Saint Hubert (CA); Mohamed Ahmed NASR, Verdun (CA)

(72) Inventors: Ahmed Abdelwahed KISHK, Saint Hubert (CA); Mohamed Ahmed NASR, Verdun (CA)

(21) Appl. No.: 16/915,445

(22) Filed: Jun. 29, 2020

Related U.S. Application Data
(60) Provisional application No. 62/869,104, filed on Jul. 1, 2019.

(51) Int. Cl. H01P 3/123; H01P 5/107; H01P 5/12

(52) U.S. Cl. CPC H01P 3/123; H01P 5/12; H01P 5/107

(57) ABSTRACT

Ridge Gap Waveguide (RGW) has emerged as a preferred waveguide technology for millimeter-wave frequencies. Microwave power splitters and switches represent important components for routing microwave signals and/or splitting a microwave signal into equal or unequal portions. To date, solutions have typically employed MEMS phase shifters, MEMS reflective loads, etc. or monolithic microwave integrated circuits to replace traditional electromechanical switches. However, such devices have typically demonstrated at frequencies below 18 GHz and require transitions to/from the RGW. The inventors have established an alternate design, which provides a reconfigurable power splitter and/or microwave switch, which is directly within the same metallic RGW waveguide technology. Such RGW power splitters and switches operating at higher frequencies, such as 26 GHz-40 GHz, for example.

### CROSS-REFERENCE TO RELATED APPLICATIONS

This patent application claims the benefit of priority from U.S. Provisional Patent Application 62/869,104 filed Jul. 1, 2019 entitled “Ridge Gap Waveguide Switches and Reconfigurable Power Splitters,” the entire contents of which is incorporated herein by reference.

### FIELD OF THE INVENTION

This patent application relates to ridge gap waveguides and, more particularly, to providing ridge gap waveguide switches and ridge gap waveguide reconfigurable power splitters.

### BACKGROUND OF THE INVENTION

Ridge Gap Waveguide (RGW) has emerged as a preferred waveguide technology for millimeter-wave frequencies. RGW is a quasi TEM contactless waveguide which does not need contact between its upper and lower halves in order to confine the microwave signal inside the waveguide. Rather, a periodic structure of raised elements, commonly referred to as a “bed of nails” is utilized on one of the upper and lower halves with the other half left smooth while maintaining a gap of less than or equal quarter wavelength between the two halves. Accordingly, the height of the nails is designed to be around a quarter wavelength in order for the nails to represent an Artificial Magnetic Conductor (AMC), which is the practical realization for Perfect Magnetic Conductor (PMC).

Microwave power splitters have been used for a long time in microwave engineering to split a microwave signal into equal or unequal portions for several applications such as reconfigurable antenna systems, phased array radar, etc. An early example of microwave power splitters is the Wilkinson power divider with equal/unequal N-way power division. Reconfigurable power splitters/dividers are addressed by several authors within the prior art such as a programmable power divider/combiner using a pair of 3 dB couplers separated by microelectromechanical systems (MEMS) controlled reflection-type phase shifter to achieve a 20 dB matching level over a 300 MHz bandwidth from 11.6 GHz to 11.9 GHz with 5 division states. Another approach in the prior art exploits a microstrip technology power divider using MEMS controlled reflective loads over a frequency range of 1.69 GHz to 3.47 GHz with a continuously variable division ratio from 0.135:1 to 1:0.063 with an insertion loss better than 0.7 dB. Similarly, a reconfigurable power divider with a 3:1 division ratio has been reported and realized using coupled lines and parasitic pin diodes within microstrip.

Now considering microwave switches, then within the prior art, substantial work on monolithic microwave integrated circuits (MMICs) has been reported, typically exploiting gallium arsenide (GaAs) or indium phosphide (InP) semiconductor material systems, as a means of providing an alternative to electromechanical devices. However, most MMIC devices tend to operate below 18 GHz and require that the microwave signals be coupled into and out of their waveguide domain to the MMIC. Similarly, electromechanical switches tend to be connectorized for connection to microwave cables, although devices do exist for conventional rectangular metallic waveguides.

Accordingly, it would be beneficial to provide microwave system designers with a reconfigurable power splitter/switch, which could be implemented within the same metallic waveguide technology as used for the remainder of a microwave system. Accordingly, reconfigurable power splitters/switches exploiting RGW have been established by the inventors.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to ridge gap waveguides and more particularly to providing ridge gap waveguide switches and ridge gap waveguide reconfigurable power splitters.

In accordance with an embodiment of the invention, there is provided a method comprising:
providing a first ridge gap waveguide (RGW) comprising:
   an upper structure comprising a periodic structure comprising a plurality of pins disposed on a solid conductor;
   a lower structure comprising a periodic structure comprising a plurality of pins disposed on a solid conductor;
a cantilevered sheet disposed between the upper structure of the first RGW and the lower structure of the first RGW; wherein
the plurality of pins of the upper structure of the first RGW are disposed towards the plurality of pins of the lower structure of the first RGW;
the upper structure of the first RGW and the lower structure of the first RGW are disposed a predetermined distance apart; and
variation of gaps between the cantilevered sheet and each of the upper structure of the first RGW and the lower structure of the first RGW results in a variation of splitting, microwave power guided within the first RGW to each of a second RGW comprising the upper structure only and a third RGW comprising the lower structure only.

In accordance with an embodiment of the invention, there is provided a method of distributing a microwave signal from an input waveguide to a pair of output waveguides comprising:
providing the input waveguide comprising a first “bed of nails” (BEONA) structure upon a first conductive plate and a second BEONA structure upon a second conductive plate where the first BEONA structure and second BEONA structure face one another with a predetermined separation between them;
providing a first output waveguide of the pair of output waveguides comprising a third BEONA structure upon a third conductive plate;
providing a second output waveguide of the pair of output waveguides comprising a fourth BEONA structure upon a fourth conductive plate;
providing a splitting region comprising:
   a first port coupled to the input waveguide;
   a second port coupled to the first output waveguide;
   a third port coupled to the second output waveguide;
   a fifth BEONA structure;
   a sixth BEONA structure; and
   a conductive plate disposed between the fifth BEONA structure and the sixth BEONA structure: wherein
the third BEONA structure and fourth BEONA structure face another initially as they couple to the second port and third port of the splitting region;
a first portion of the microwave signal coupled to the input waveguide is coupled to the first output waveguide in dependence upon a position of the conductive plate relative to the fifth BEONA structure and the sixth BEONA structure; and
a second portion of the microwave signal coupled to the input waveguide is coupled to the second output waveguide in dependence upon a position of the conductive plate relative to the fifth BEONA structure and the sixth BEONA structure.

In accordance with an embodiment of the invention, there is provided a device comprising:
a first ridge gap waveguide (RGW) comprising:
   an upper structure comprising a periodic structure comprising a plurality of pins disposed on a solid conductor; and
   a lower structure comprising a periodic structure comprising a plurality of pins disposed on a solid conductor; and
a cantilevered sheet disposed between the upper structure of the first RGW and the lower structure of the first RGW; wherein
the plurality of pins of the upper structure of the first RGW are disposed towards the plurality of pins of the lower structure of the first RGW;
the upper structure of the first RGW and the lower structure of the first RGW are disposed a predetermined distance apart; and
variation of gaps between the cantilevered sheet and each of the upper structure of the first RGW and the lower structure of the first RGW results in a variation of splitting microwave power guided within the first RGW to each of a second RGW comprising, the upper structure only and a third RGW comprising the lower structure only.

In accordance with an embodiment of the invention, there is provided a device for distributing a microwave signal from an input waveguide to a pair of output waveguides comprising:
the input waveguide comprising a first “bed of nails” (BEONA) structure upon a first conductive plate and a second BEONA structure upon a second conductive plate where the first BEONA structure and second BEONA structure face one another with a predetermined separation between them;
a first output waveguide of the pair of output waveguides comprising a third BEONA structure upon a third conductive plate:
a second output waveguide of the pair of output waveguides comprising a fourth BEONA structure upon a fourth conductive plate;
a splitting region comprising:
   a first port coupled to the input waveguide;
   a second port coupled to the first output waveguide;
   a third port coupled to the second output waveguide;
   a fifth BEONA structure;
   a sixth BEONA structure; and
   a conductive plate disposed between the fifth BEONA structure and the sixth BEONA structure; wherein
the third BEONA structure and fourth BEONA structure face another initially as they couple to the second port and third port of the splitting region;
a first portion of the microwave signal coupled to the input waveguide is coupled to the first output waveguide in dependence upon a position of the conductive plate relative to the fifth BEONA structure and the sixth BEONA structure; and
a second portion of the microwave signal coupled to the input waveguide is coupled to the second output waveguide in dependence upon a position of the conductive plate relative to the fifth BEONA structure and the sixth BEONA structure.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a top view of a ridge gap waveguide (RGW) reconfigurable power splitter or switch (REPSS) with the top cover removed according to an embodiment of the invention;

FIG. 1B depicts a perspective view of an RGW REPSS with the top cover removed according to an embodiment of the invention;

FIG. 1C depicts simulated S-parameters for an RGW reconfigurable power splitter (REPS) according to an embodiment of the invention for two different split rations over the frequency range 14 GHz-22 GHz;

FIG. 2 depicts a perspective view and cross-sections for an RGW REPPS according to an embodiment of the invention;

FIG. 3 depicts perspective views of an RGW REPPS according to an embodiment of the invention and its constituent piece-parts;

FIG. 4 depicts a design geometry for an RGW REPPS according to an embodiment of the invention;

FIG. 5 depicts an exemplary flow chart for the design procedure for an RGW REPPS according to an embodiment of the invention;

FIG. 6 depicts the unit cells employed in the simulations within the design procedure for an RGW REPPS according to an embodiment of the invention;

FIG. 7 depicts the unit cell and dispersion for the DRGW element in Guide 1 for an RGW REPPS according to an embodiment of the invention;

FIG. 8 depicts the unit cell and dispersion for a single row DRGW in Guide 1 for an RGW REPPS according to an embodiment of the invention;

FIG. 9 depicts the unit cell and dispersion for the DRGW in Guides 2 and 3 for an RGW REPPS according to an embodiment of the invention:

FIG. 10 depicts the unit cell and dispersion for a single row DRGW in Guides 2 and 3 for an RGW REPPS according to an embodiment of the invention;

FIG. 11 depicts the one row and cross-section of the packaged soft surface for an RGW REPPS according to an embodiment of the invention;

FIG. 12 depicts the simulation results for the available bandwidths for the whole structure for different dimensions of the packaged soft surface for an RGW REPPS according to an embodiment of the invention;

FIG. 13 depicts the simulation results for the one soft surface scenario for an RGW REPPS according to an embodiment of the invention;

FIG. 14 depicts the simulation results for the two soft surface scenario for an RGW REPPS according to an embodiment of the invention;

FIG. 15 depicts simulation results for an RGW REPPS according to an embodiment of the invention with the conductor plane in its “neutral” central position such that the RGW REPPSS acts as a 3 dB splitter;

FIG. 16 depicts simulation results for an RGW REPPS according to an embodiment of the invention with the conductor plane offset by 0.1 mm such that the RGW REPPSS acts as a 25:75% power splitter; and

FIG. 17 depicts simulation results for an RGW REPPS according to an embodiment of the invention with the conductor plane offset by 0.2 mm such that the RGW REPPSS acts as a 100% power splitter/switch.

### DETAILED DESCRIPTION

The present invention is direct to ridge gap waveguides and more particularly to providing ridge gap waveguide switches and ridge gap waveguide reconfigurable power splitters.

The ensuing description provides representative embodiment(s) only and is not intended to limit the scope, applicability, or configuration of the disclosure. Rather, the ensuing description of the embodiment(s) will provide those skilled in the art with an enabling description for implementing an embodiment or embodiments of the invention. It is understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments,” or “other embodiments” means that a particular feature, structure, or characteristic described in connection with the embodiments is included in at least one embodiment, but not necessarily all embodiments, of the inventions. The phraseology and terminology employed herein are not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can,” or “could” be included, that particular component, feature, structure, or characteristic is not required to be included.

Reference to terms such as “left,” “right,” “top,” “bottom,” “front,” and “back” are intended for use in respect to the orientation of the particular feature, structure, or element within the figures depicting embodiments of the invention. It would be evident that such directional terminology with respect to the actual use of a device has, no specific meaning, as the device can be employed in a multiplicity of orientations by the user or users.

Reference to terms “including,” “comprising,” “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

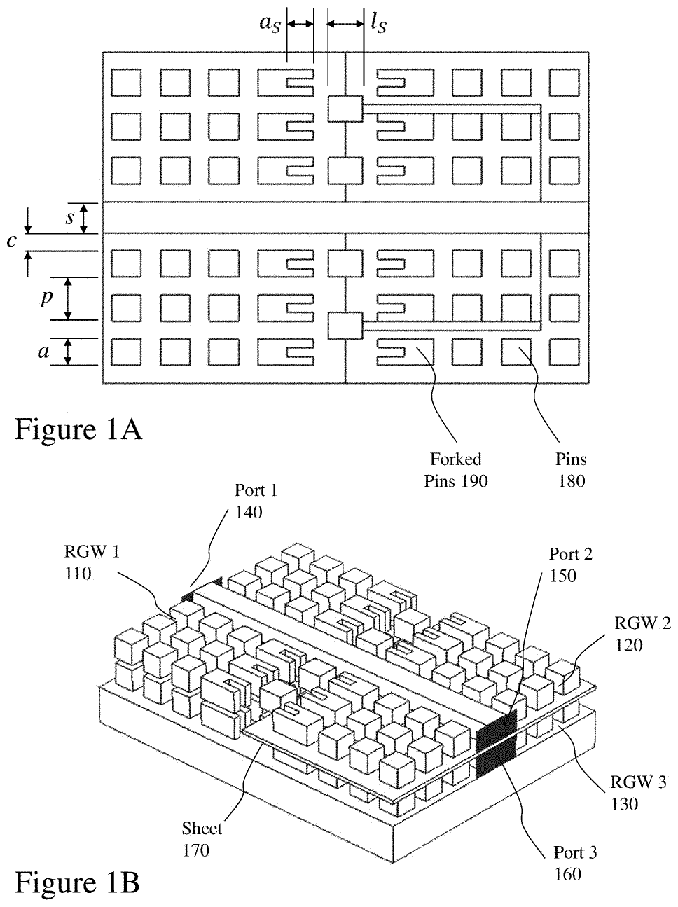

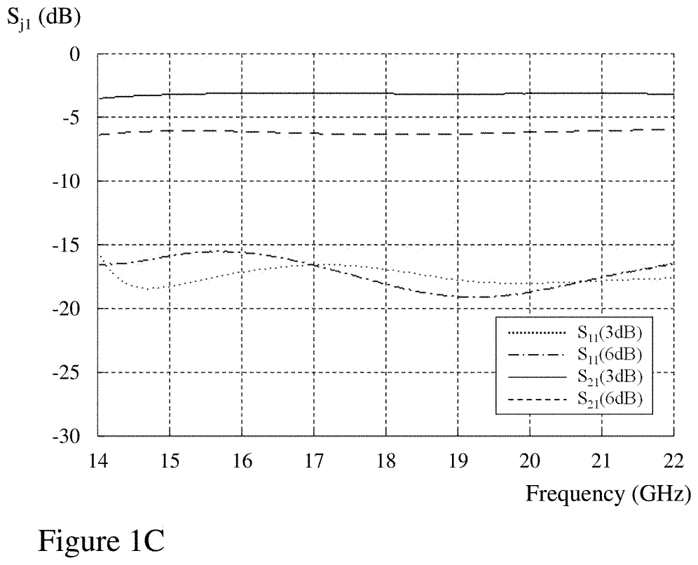

A ridge gap waveguide (RGW) reconfigurable power splitter/switch (REPSS) according to an embodiment of the invention is depicted in FIG. 1A in plan view with the top cover removed and FIG. 1B in perspective view with the top cover removed. The REPSS consists of 3 waveguides, two of which RGW 2 120 and RGW 3 130 are regular RGWs with a height of 3 mm separated by a 0.5 mm thick metallic sheet while the remaining waveguide, RGW 1 110, is generated by removing the sheet between the other two guides creating a ridge surrounded by the “bed of nails” (BEONAs) structures on both its upper and lower surfaces. The parameters of RGW 1 110, RGW 2 120, and RGW 3 130 are given below in Table 1. The gap between the BEONA and the metallic sheet 170 in RGW 2 120, upper waveguide as depicted, is 0.3 mm while the same gap in RGW 3 130 is 0.1 mm. In order to split the power, then the microwave signals are assumed to enter the REPSS from Port 1 140 and leave it at Ports 2 150 in RGW 2 120 and Port 3 160 in RGW 3 130 after being divided by the sheet at the middle of the structure. The ridge heights on the upper and lower plates are both designed to be equal to 2.7 mm, which means equal power splitting.

TABLE 1
Design Parameters for BEONAs of Exemplary REPSS

| Parameter | Value (mm) |
|---|---|
| a | 3.0 |
| p | 5.0 |
| c | 2.0 |
| s | 3.5 |
| aₛ | 2.7 |
| lₛ | 3.5 |

In order to establish either variable power splitting or switching a portion of the central sheet can be moved like a cantilever. For example, within embodiments of the invention, this is implemented by creating two slits in the sheet 170 wherein mechanical screws can be employed to bend the sheet 170 from its initial configuration, bent downwards, such that its deflection can be reduced and then reversed so that the sheet bends upwards. Alternatively, the sheet may be initially biased upwards and deflected down, or it may be biased neutrally and deflected in either direction.

Within the configuration with the sheet with splits, the length of the slit is inversely proportional to the force needed to deflect the sheet as well as also controlling the matching. In the exemplary REPSS depicted in FIGS. 1A and 1B, then the length and width of the slit in the design are 20 mm and 1 mm, respectively. Whilst initial embodiments of the invention exploit mechanical screws to deflect the ground sheet 170; this may be controlled through electromechanical drives such as inchworm drives, leadscrews, ball screw drives, roller screw drives, cams, etc. Optionally, within other embodiments of the invention, electromechanical drives may be replaced with microelectromechanical systems (MEMS) drives.

As the sheet 170 supports horizontal polarization signals, these cannot be confined by a BEONA and accordingly, what is referred to as a soft surface is created at the splitting region to confine both the horizontally and vertically polarized signals whilst fork-shaped (forked) pins 190 are used to prevent leakage at the soft surface-to-pins transition region. The BEONA employing pins 180.

Proper operation of the REPSS according to embodiments of the invention requires that the microwave signals are confined around the ridges and away from the pins in the three guides. Accordingly, it is necessary to study the dispersion diagram of one row for each of the 3 guides. The one-row dispersion diagram of RGW 1 110, RGW 2 120, and RGW 3 130 were performed as depicted and described below. Accordingly, a common single mode bandwidth from 14 GHz to 23 GHz was verified in the three waveguides.

The profile by which the applied force deflects the cantilever controls matching of the REPSS at different splitting ratios, and it can be established through considering that the sheet disposed between the pair of RGWs, e.g., RGW 2 120 and RGW 3 130 in FIGS. 1A and 1B, is a horizontal fixed-free cantilever wherein a force, F, is vertically applied at its free end can be established from Equation (1) below where E is Young's modulus of the material of the sheet, x is the horizontal dimension, L is the cantilever length, and δ(x) is the vertical displacement due to F(x). For example, considering the sheet formed from aluminum then E=68.9 kN/mm² although it would be evident that the sheet may be formed from a variety of materials including other metals, alloys, conductive polymers, and materials coated with conductive coatings.

δ(x)=(2Fx²/Ewt²)(3L−x) (1)

The REPSS depicted in FIGS. 1A, and 1B respectively was simulated using ANSYS, engineering simulation, and three-dimensional design software, whilst employing the profile defined by Equation (1) to shape the cantilever. Referring to FIG. 1C, the simulation results for two different sheet spacings are depicted. In each instance, the transmission, S₂₁, and reflection, S₁₁. Results are depicted for the scenarios of 3 dB and 6 dB power splitting showing, a flat frequency response from 14 GHz to 22 GHz as the splitting ratio is varied according to the deflection of the cantilever.

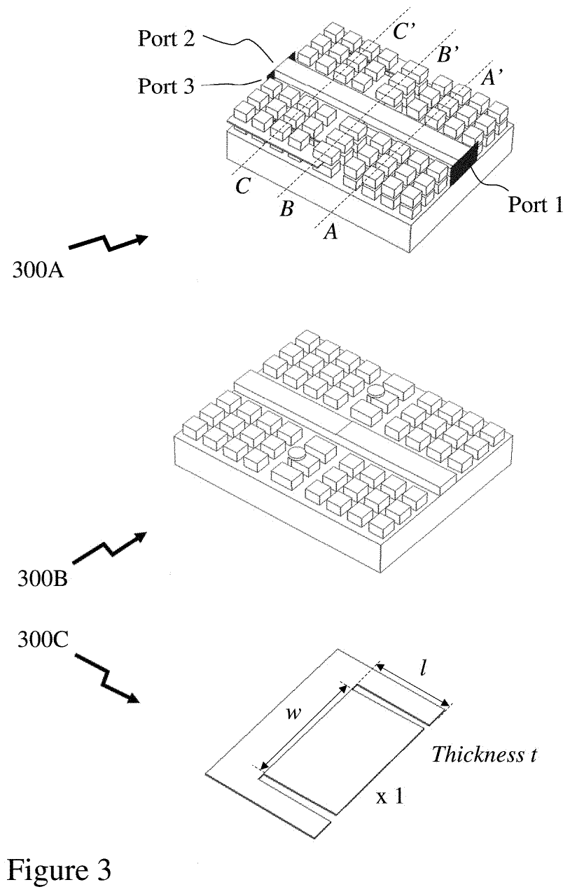

Accordingly, the REPSS depicted in FIGS. 1A and 1B can provide a reconfigurable tunable power splitter and/or switch for integration within RGW structures. Within the following description with respect to FIGS. 3 to 17, the design of the REPSS and the simulation process are presented in more detail than that above in respect of FIGS. 1A to 1C, respectively, which provide a summary of the design concept.

As noted above, Ridge Gap Waveguide (RGW) is a quasi-TEM waveguide that requires no tight contact between the upper and lower waveguide halves to operate and which is self-packaged. This is due to the presence of the periodic structure, commonly referred to as a “bed of nails” (BEONA) formed on each of the two sides of the ridge where its upper surface which provides an Artificial Magnetic Conductor (AMC) is less than a quarter wavelength apart from the flat external plate which provides a practical realization of a Perfect Magnetic Conductor (PMC). Beneficially, RGW does not require a dielectric within the structure, and accordingly, lower losses are expected when compared to conventional printed circuits. These factors make RGW an ideal candidate for waveguides at high frequencies.

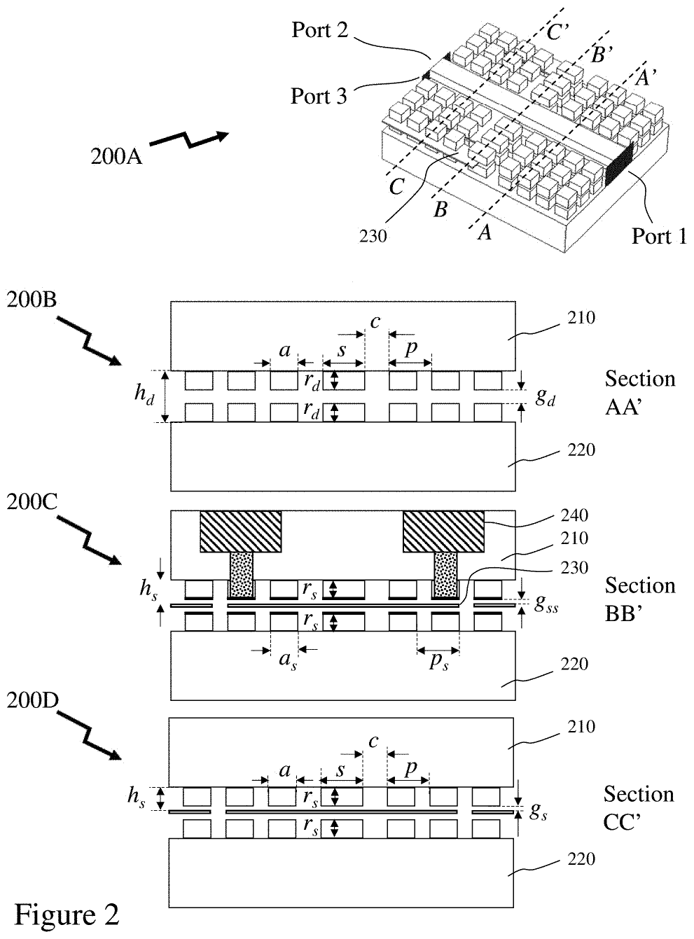

Referring to FIG. 2 in first image 200A, an exemplary construction of an RGW REPSS according to an embodiment of the invention is depicted wherein the upper metal cover has been removed to allow the internal geometry to be visible. Accordingly, the REPSS comprises a movable cantilever (sheet) 230 disposed within a pair of RGW BEONA structures above the cantilever (sheet) 230. Accordingly, the pair of RGW BEONA structures sandwich the sheet 230 to form a 3-port structure as shown in the second to fourth images 200B to 200D, respectively, which depicted cross-sections A-A′, B-B′ and C-C′ respectively. Accordingly, at the right band side of the REPSS in first image 200A, the common port, Port 1, has the cross section shown in section A-A′ in second image 200B wherein the upper BEONA 210 and lower BEONA 220 form the waveguide (Guide 1). A left hand side of the REPSS the pair of output ports, Port 2 and Port 3 being represented respectively by the upper BEONA 210 with sheet 230 (Guide 2) and lower BEONA 220 and sheet 230 (Guide 3). This being depicted in third and fourth images 200C and 200D respectively wherein third image 200C depicts the region wherein the cantilever actuators 240 are depicted which as described above deflect the cantilever, sheet 230, to configure the REPSS. Accordingly, microwave power entering the structure at Port 1 passes through Guide 1 until it reaches the sheet 230, which divides Guide 1 into Guide 2 and Guide 3, which end by Ports 2 and 3, respectively. The vertical position of the cantilever tip determines the power split ratio. At section B-B′ the modified portions of each of BEONA provide packaged soft surfaces, which prevent leakage of any polarization signals within the REPSS.

Accordingly, as depicted in FIG. 3 wherein first image 300A is the same perspective view as first image 200A in FIG. 2 the REPSS can be formed within embodiments of the invention from a pair of BEONA structures, depicted in second image 300B in FIG. 3, and a cantilever, depicted in third image 300C in FIG. 3, together with one or more actuators to deflect the cantilever (not depicted for clarity) which may be mechanical or electromechanical in operation, for example.

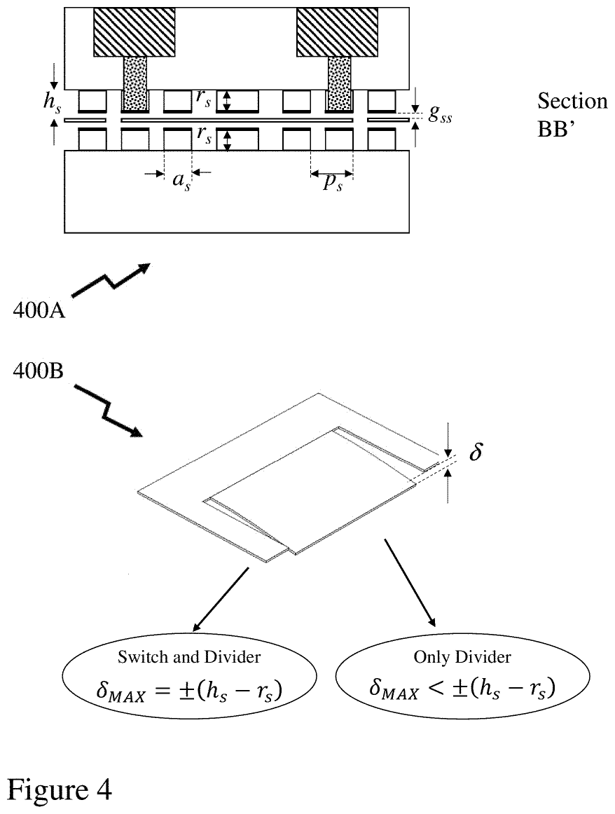

As depicted in the first image 400A in FIG. 4, which is equivalent to third cross-section 200C in FIG. 2, the BEONA has an outer body which is separated from the sheet by a distance h_{S} whereas the “nails” or periodic structures formed on the outer body have a height h_{S}, lateral width a_{S}, and periodicity p_{S}. The sheet is separated from the inner surface of the periodic structures by g_{SS}. The REPSS acts as only a power splitter when δ_{MAX}=g_{SS}<(h_{S}−r_{S}) and acts both as a power splitter and a switch when δ_{MAX}=(h_{S}−r_{S}). Considering the deflection for the second case, the REPSS behaves as a 50:50 power splitter when S=0 and behaves as a switch when δ=δ_{MAX}. Accordingly, between these limits the REPSS acts as a variable power splitter according to the deflection and direction of the deflection.

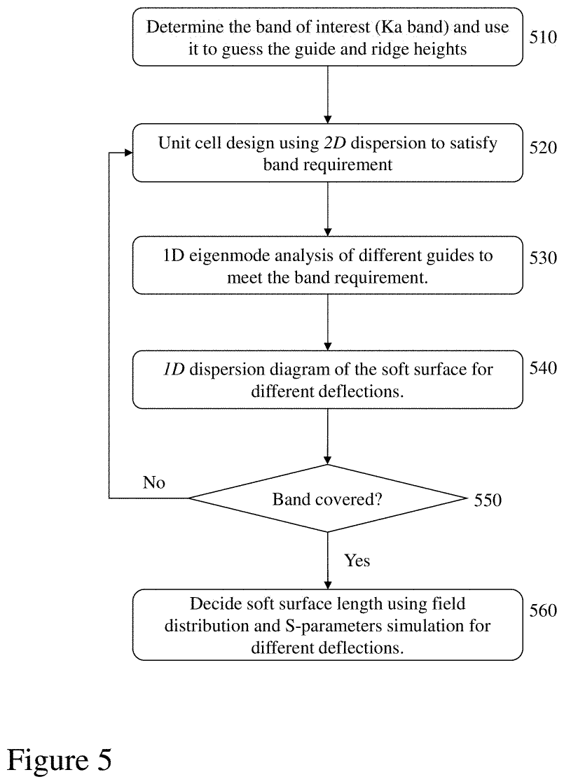

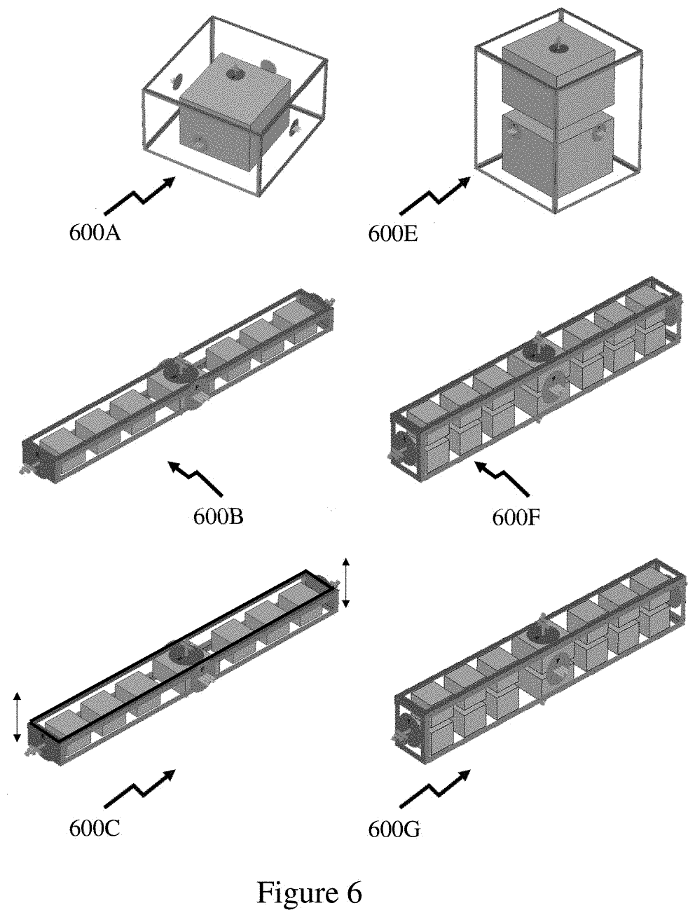

Referring to FIG. 5, there is depicted an exemplary process flow relating to the design of a REPSS according to an embodiment of the invention. At first step 510, the design process beings by determining the band of interest over which the REPSS is intended to operate and using it to provide an initial guess for guides and ridge heights. Within this specification and descriptions of embodiments of the invention, the band of interest is the Ka-band (26.5 GHz-40 GHz), although it would be evident that the design process may be applied to other bands, parts of bands, or defined frequency ranges. Next in second step 520 a two-dimensional (2D) eigenmode analysis for the unit cells of guides 1 and 2 is performed (these being depicted as first and fourth images 600A and 600E respectively in FIG. 6) wherein the dimensions are tuned to make the band of interest of the REPSS within their stopband. Subsequently, in third step 530 a one-dimensional (1D) eigenmode analysis is performed for one row of Guides 1 and 2 (these being depicted in second and fifth images 600B and 600F respectively in FIG. 6) in order to ensure that the single mode bandwidth of these contains the band of interest.

Next is the fourth step 540 the packaged soft surfaces are analyzed in both the double and single ridge cases using 1D eigenmode analysis to guarantee no leakage for different deflections. These being depicted by third and sixth images 600C and 600G, respectively in FIG. 6. Based upon this, then a determination is made in fifth step 550 as to whether the band of interest is contained in the intersection bandwidths determined in third and fourth steps 530 and 540, respectively. If the band of interest is not contained within these, then the process iterates back to second step 520 wherein the parameters are modified, and the simulations re-run through second to fourth steps 520 to 540, respectively. If required, the required band is covered then S-parameters are used to decide the length of the soft surface in sixth step 560. It would be evident that whilst not depicted, a final check (to see if required performance is achieved) may be performed after sixth step 560 wherein the design may be established when the required performance is met for different deflections, or the design process iterates back if not.

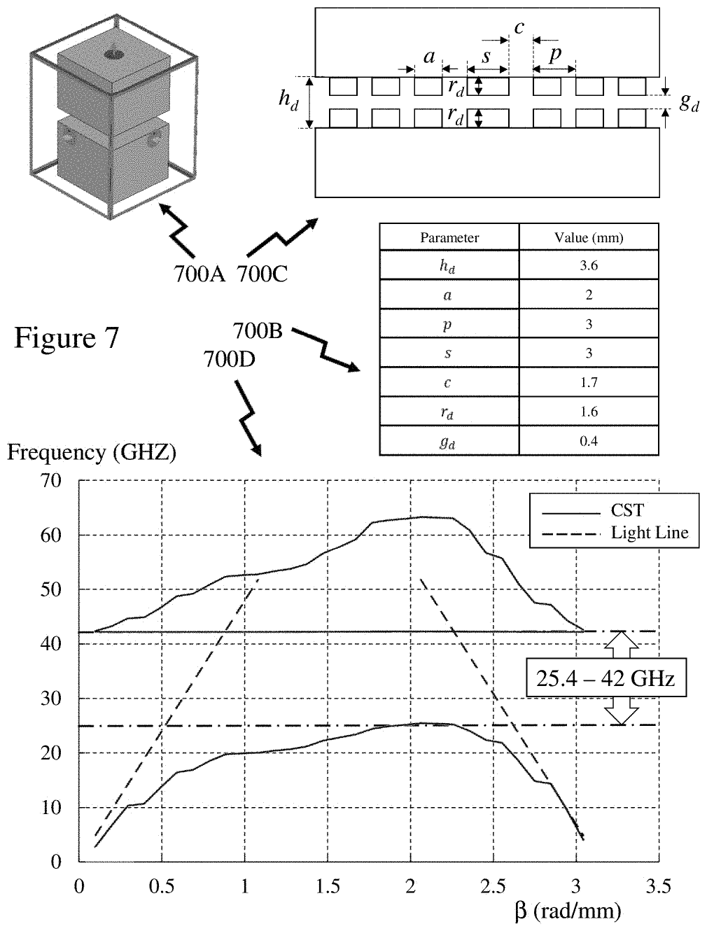

Now referring to FIG. 7, the 2D dispersion diagram of the unit cell in image 700A is depicted in the image 700D where the top and bottom boundaries are PEC, and the rest of boundaries are periodic. The parameters used in this simulation and their representations within the guide 1 structure are depicted in second and third images 700B and 700C, respectively, in FIG. 7. Accordingly, it is evident from the fourth image 700D that no propagation exists between 25.4 to 42 GHz, which includes the Ka-band of interest for this exemplary design.

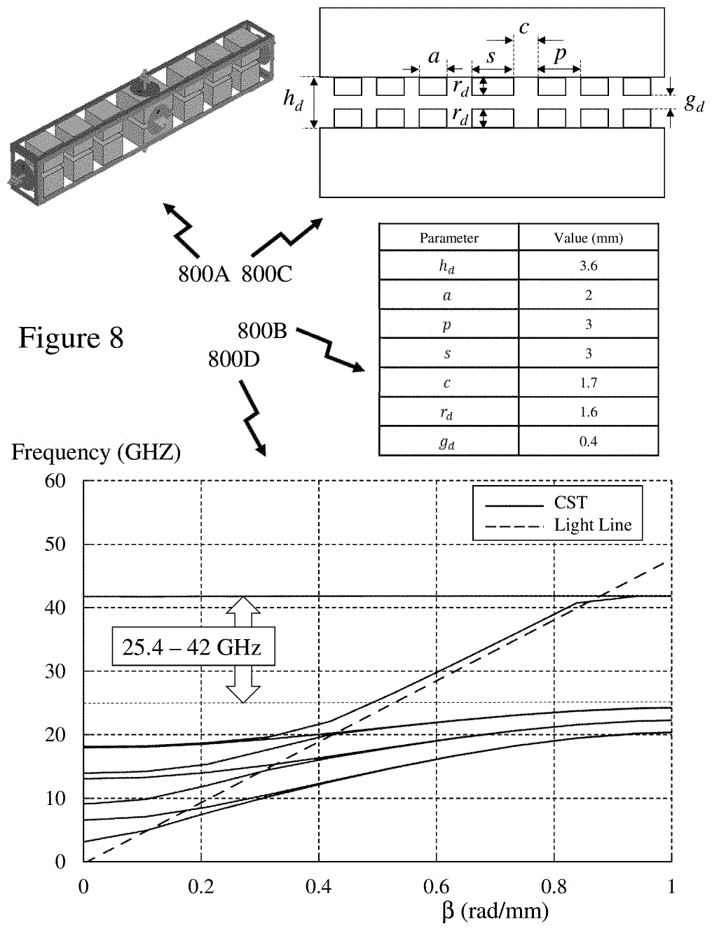

Now referring to FIG. 8, the 1D dispersion diagram for the guide 1 unit cell (depicted in first image 800A) is depicted in fourth image 700D. The parameters used in this simulation and their representations within the Guide 1 structure are depicted in second and third images 800B and 800C, respectively in FIG. 8. Accordingly, it is evident from the fourth image 800D that the single mode bandwidth from the 1D eigenmode analysis is almost the bandgap of a unit cell of Guide 1.

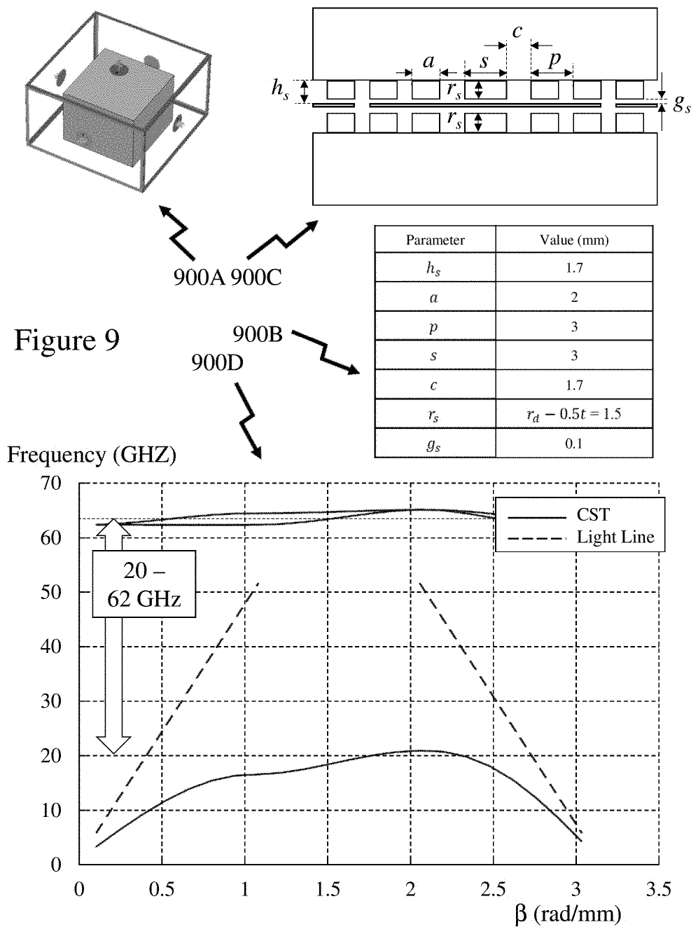

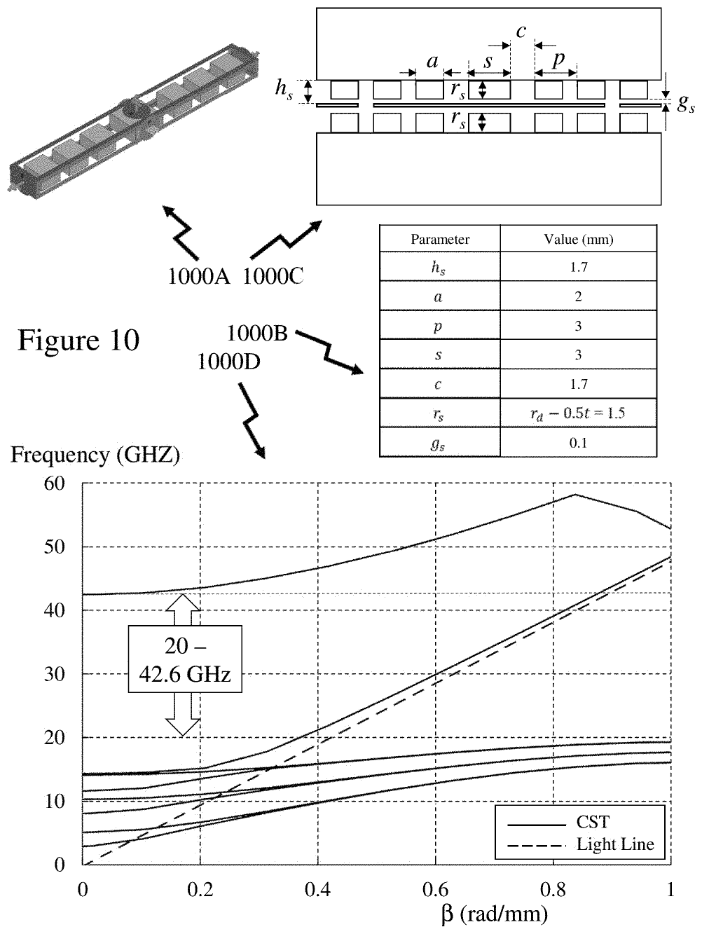

Now referring to FIGS. 9 and 10, respectively, there are depicted the simulations for Guides 2 and 3. Referring to FIG. 9, there is depicted the 2D dispersion diagram in the fourth image 900D for the Guide 2 (Guide 3) unit cell depicted in the first image 900A. The parameters used in this simulation and their representations within the Guide 1 structure are depicted in second and third images 900B and 900C, respectively in FIG. 9. Similarly, referring to FIG. 10, there is depicted the 1D dispersion diagram in the fourth image 1000D for Guide 2 (Guide 3) unit cell depicted in first image 1000A. The parameters used in this simulation and their representations within the Guide 2 (Guide 3) structure are depicted in second and third images 1000B and 1000C, respectively in FIG. 10, Accordingly, it is evident from FIGS. 9 and 10 that the 2D unit cell bandwidth of 20-62 GHz and the 1D simulation covering 20-42.6 GHz both cover the Ka-band of interest.

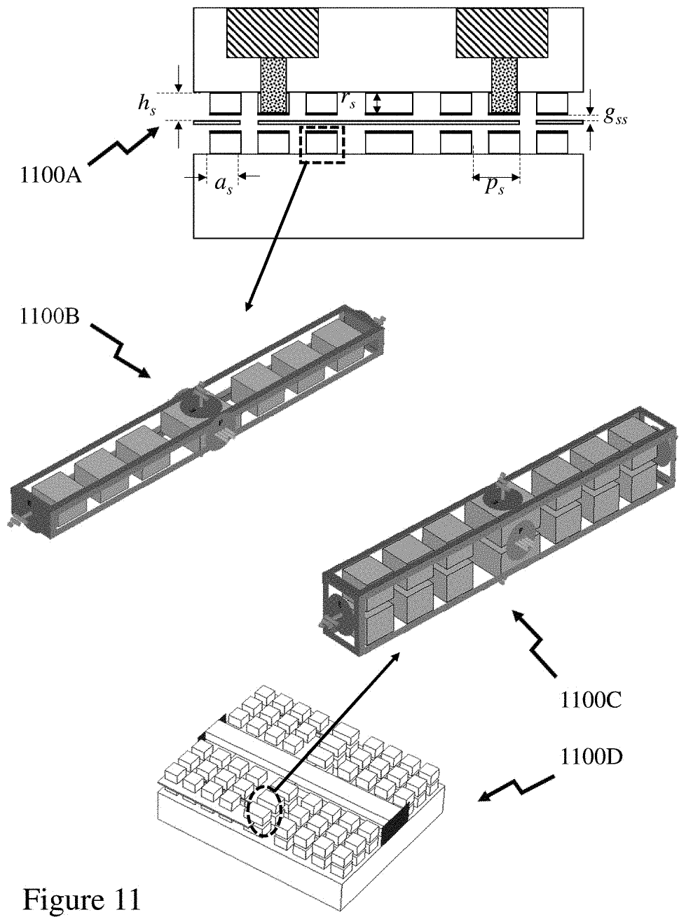

Now, referring to FIG. 11, the packaged soft surface analysis is depicted, which is performed to ensure that its stopband covers the band of interest, in this embodiment of the invention of the Ka-band. In order to perform this analysis, a 1D dispersion diagram is required twice, once in the region where the sheet separates Guide 1 into Guides 2 and 3 and the other in the region where the design provides two soft surfaces on top of each other. This being depicted with respect to the unit cells depicted in second and third images 1100B and 1100C, respectively, which are referenced to the cross-section in first image 1100A and perspective view 1100D in FIG. 11.

As noted above, packaged soft surfaces are employed to prevent the horizontal and vertical polarizations from propagating to the side of the ridge. Accordingly, within the single packaged soft surface analysis, the sheet deflection within the REPSS will change the height of the gap. Accordingly, this has to be taken into consideration when performing the 1D eigenmode analysis so that even with maximum cantilever deflection power confinement is maintained at the ridges. Accordingly, referring to Equations (2) and (3) we define a maximum soft surface gap g_{SS_MAX} and a maximum guide height h_{SS_MAX}. This leads to the conditions in Equation (4). These parameters, g_{SS_MAX} and h_{S_MAX} are employed in obtaining the correct value for the grating height h_{SS}. Accordingly, initially 1D eigenmode simulation of the soft surface is performed in order to obtain g_{SS_MAX} for different a_{SS} and height of the grating h_{SS} covering the band of interest.

g_{SS_MAX}≥g_{SS}+δ_{MAX} (2)

h_{S_MAX}≥h_{S}+δ_{MAX} (3)

δ_{MAX}=(h_{S}−r_{S})<g_{SS} or δ_{MAX}=g_{SS}<(h_{S}−r_{S}) (4)

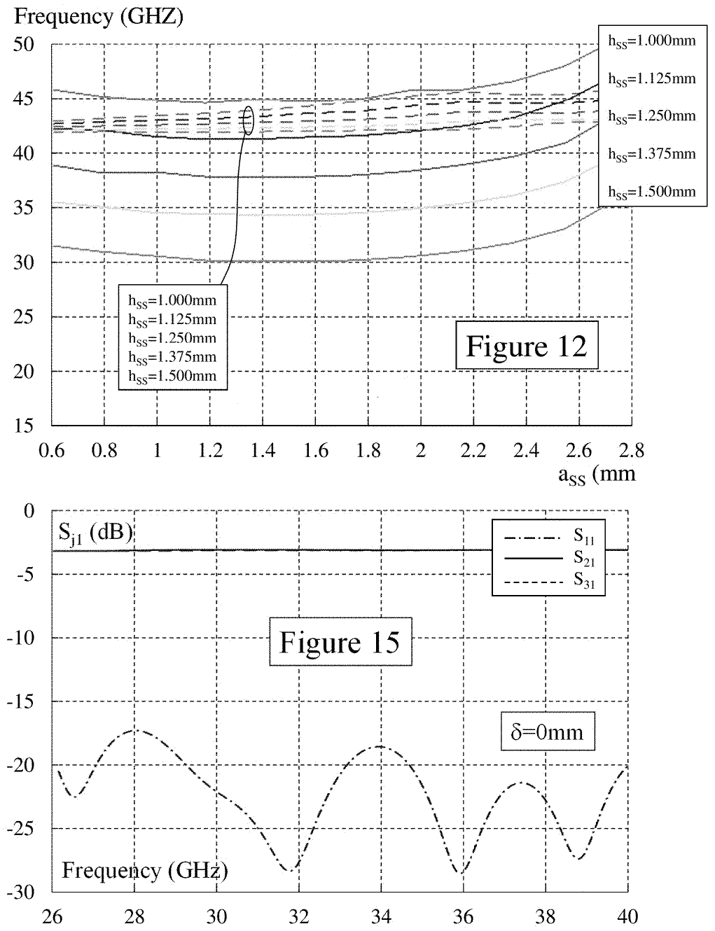

In order to get this value, a parametric study is carried out on the thickness of the soft surface grating a_{SS} and grating height h_{SS} to determine the bandwidth of the structure in the worst case scenario where the maximum deflection of the sheet exists. The bandwidth, for each case, is calculated as the intersection bandwidth of the three guides. Accordingly, referring to FIG. 12 these results are depicted as the highest and lowest frequencies of the available bandwidth wherein it is evident that for different values of a_{SS} and h_{SS}, different bandwidths may be obtained.

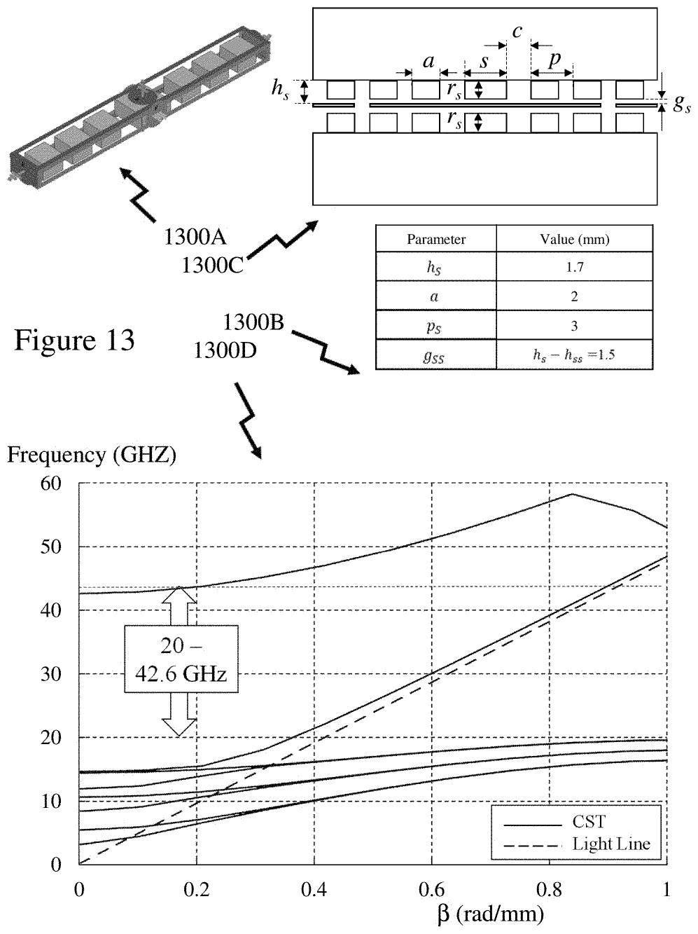

Referring to FIG. 13, the packaged soft dispersion diagram is depicted in the fourth image 1300D for the single row depicted in the first image 1300A. The parameters used in this simulation and their representations within the exemplary REPSS structure are depicted in second and third images 1300B and 1300C, respectively, in FIG. 13. Accordingly, it is evident from the fourth image 1300D that the bandgap achieved from 20 GHz to 42.6 GHz, which includes the Ka-band of interest for this exemplary design.

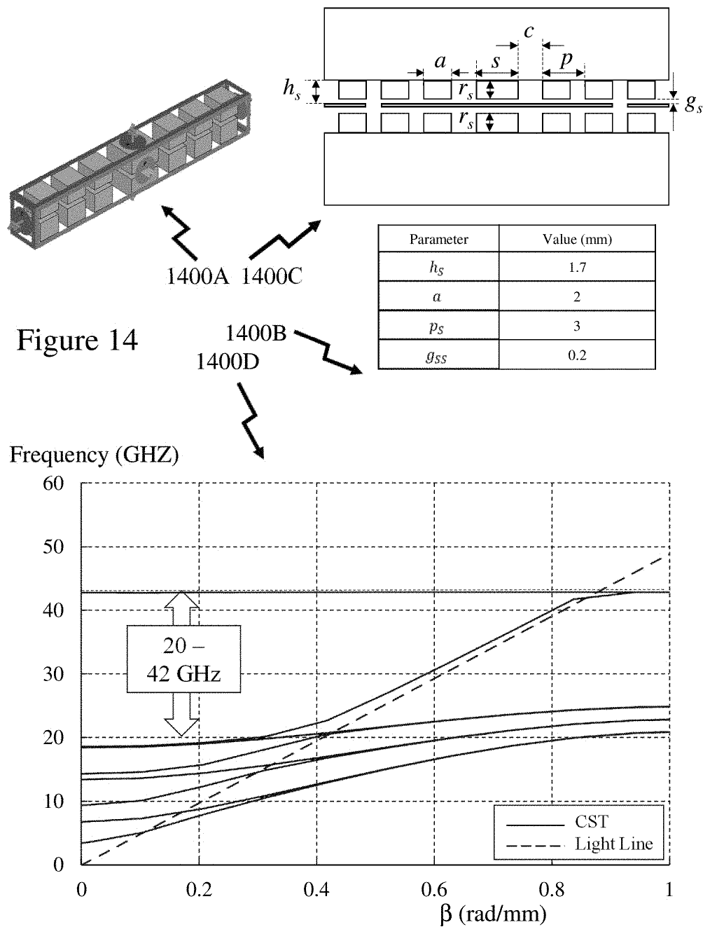

Referring to FIG. 14, the packaged soft dispersion diagram is depicted in fourth image 1400D for the two soft surface scenarios where the deflection does not have to be taken into consideration with the single row depicted in the first image 1400A. The parameters used in this simulation and their representations within the exemplary REPSS structure are depicted in second and third images 1400B and 1400C, respectively, in FIG. 14. Accordingly, it is evident from the fourth image 1400D that the bandgap is from 25 GHz to 42 GHz, which includes the Ka-band of interest for this exemplary design.

Now referring to FIG. 15, there are depicted results for the full structure designed using the process described in FIG. 5 with the design established through FIGS. 6 to 14, respectively, for the situation where the cantilever deflection is zero, δ=0. The cantilever being 12 mm long, 16 mm wide, and 0.2 mm thick. Accordingly, the transmission results are presented by curves S₂₁˜3 dB and S₃₁˜3 dB whilst the return loss is presented in the curve of S₁₁. Accordingly, it is evident that a flat power splitting is achieved over the target Ka-band from 26 GHz-40 GHz with a return loss better than approximately 17 dB over this band.

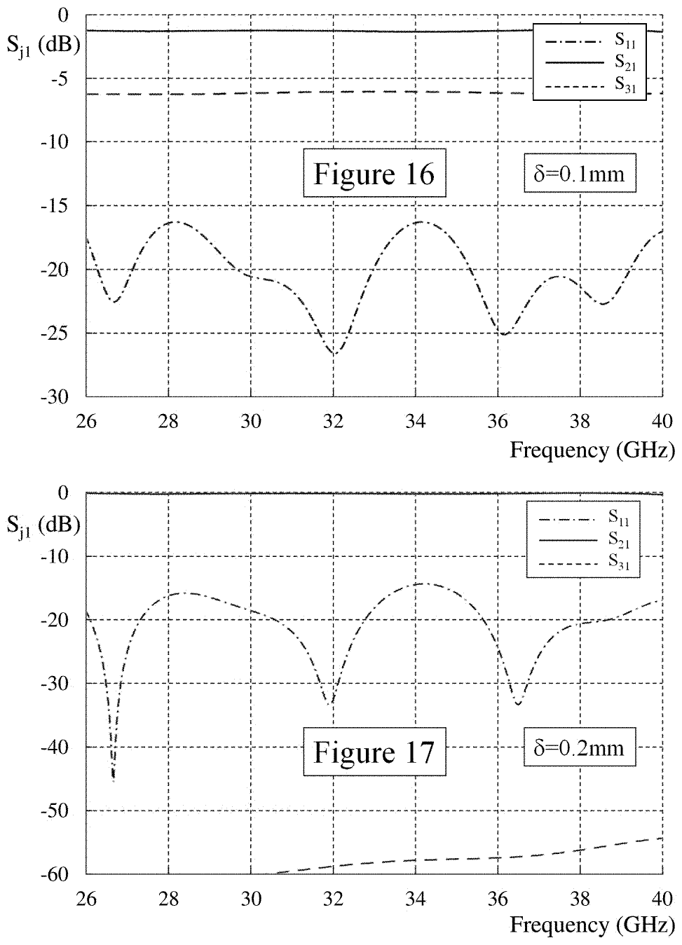

FIG. 16 depicts the simulation results for a deflection of 0.1 mm (δ=0.1 mm), wherein the power splitter is now configured as a 25:75 splitter rather than a 50:50 splitter. Accordingly, the split ratio is seen to be flat across the band of interest with a return loss of approximately 16.5 dB. Accordingly, for this deflection S₂₁˜1.5 dB and S₃₁˜6 dB.

FIG. 17 depicts the simulation results for the deflection when equals 0.2 mm (δ=0.2 mm) wherein the power splitter is now configured as a 100:0 splitter (or switch with all the power routed to one output waveguide). Accordingly, the performance across the band of interest yields a return loss of less than approximately 14 dB. Accordingly, for this deflection, S₂₁˜0 dB and S₃₁>˜54 dB across the band of interest.

Accordingly, the inventors have presented a REPSS according to embodiments of the invention compatible with direct integration within an RGW structure. It would be evident that the cantilever described within the embodiments of the invention may be activated by an appropriate means such as mechanical, electromechanical, microelectromechanical, etc. Alternatively, a fixed sheet may be employed to form a fixed RGW power splitter.

Within the initial prototypes, the sheet is an abrupt transition from the Guide 1 and accordingly, improved return loss performance may be expected through improved transitions from the Guide 1 without the sheet to the region with the sheet such as from shaping the edge of the sheet towards the input such as, for example, a linear taper in sheet thickness, rounded edge, profiled edge, etc.

Whilst within embodiments of the invention, the REPSS is implemented through the use of a cantilevered sheet other embodiments of the invention may exploit a sheet moving vertically rather than deflected may achieve similar programmable power splitting between the subsequent Guides 2 and 3.

Whilst within embodiments of the invention the REPSS is implemented through the use of a continuous upper BEONA between Guide 1 and Guide 2 and a continuous lower BEONA between Guide 1 and Guide 3 other embodiments of the invention may exploit a Guide 1 formed from first and second BEONAs whilst Guide 2 and Guide 3 are formed from third and fourth BEONA which are discontinuous with either of the first and second BEONA.

Whilst within embodiments of the invention the REPSS is implemented through the use of a cantilevered sheet other embodiments of the invention may exploit a design wherein the upper and lower BEONA which are currently depicted as continuous may be segmented, and that movement of the upper and lower BEONA relative to a fixed sheet may alternatively adjust the gaps between the sheet and the upper and lower BEONA and accordingly provide for a REPSS within an RGW structure.

Whilst within embodiments of the invention, the REPSS is implemented through the use of BEONA employing square “pins” or “nails” it would be evident that other designs of BEONA may be employed without departing from the scope of the invention.

The embodiments of the invention described and depicted above were designed to operate of over 14 GHz-23 GHz (overlapping the Ku and K bands of 12-18 GHz and 18-26.5 GHz respectively) and Ka band (26.5-40 GHz). It would be evident to one of skill in the art that the design methodologies described and depicted above may be applied to other frequency bands and/or portions of other frequency bands including, but not limited to, Q band (33-50 GHz), U band (40-60 GHz), V band (50-75 GHz), W band (75-110 GHz) and F band (90-140 GHz).

Further, it would be evident that at increasing operating frequencies with reducing dimensions of the RGW structures and their corresponding BEONA structures that hybrid integration of the RGW/BEONA structures with the cantilever and its corresponding actuator(s) may be replaced by monolithic integration of these RGW BEONA structures with the cantilever and its corresponding actuator(s).

Such monolithic integration may exploit silicon micromachining techniques such as common with microelectromechanical systems (MEMS) in order to form the BEONA structures, cantilever, and MEMS actuator(s). It would be evident that such integration may further include CMOS control and drive circuitry for the MEMS actuator(s). For example, the MEMS actuator(s), the cantilever and a first BEONA may be formed through standard silicon micromachining processes within the surface of a first silicon wafer whilst a second BEONA is formed within the surface of a second silicon wafer where these two surfaces are then disposed towards each other with a predetermined gap (itself defined by features etched during manufacturing) to form the overall device with input RGW, cantilever, transition regions, second RGW and third RGW respectively. Optionally, the cantilever and MEMS actuator(s) may be formed within the two silicon wafers. Optionally, the MEMS actuator(s) may comprise portions formed within each silicon wafer. Optionally, full monolithic integration may be obtained in manufacturing processes supporting multiple silicon or other suitable material depositions such as dielectrics with metallization, ceramics (such as aluminum nitride, silicon carbide) with metallization and silicon.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing a variable power splitter.

2. The method according to claim 1, wherein
providing the variable power splitter comprises:
providing a first ridge gap waveguide (RGW) comprising:
an upper structure comprising a periodic structure comprising a plurality of pins disposed on a solid conductor; and
a lower structure comprising a periodic structure comprising a plurality of pins disposed on a solid conductor; and
a cantilevered sheet disposed between the upper structure of the first RGW and the lower structure of the first RGW; wherein
the plurality of pins of the upper structure of the first RGW are disposed towards the plurality of pins of the lower structure of the first RGW;
the upper structure of the first RGW and the lower structure of the first RGW are disposed a predetermined distance apart; and
variation of gaps between the cantilevered sheet and each of the upper structure of the first RGW and the lower structure of the first RGW results in a variation of splitting microwave power guided within the first RGW to each of a second RGW comprising the upper structure only and a third RGW comprising the lower structure only.

3. The method according to claim 2, wherein
at least one of:
the cantilever is coupled to an actuator to adjust the gaps and the actuator is one of a mechanical actuator, an electromechanical actuator; and a microelectromechanical systems actuator; and
the cantilever is formed from an electrically conductive material or is formed from a non-conductive material with an electrically conductive outer coating.

4. The method according to claim 2, further comprising providing one or more soft surfaces at the region with the cantilever; wherein
the one or more soft surfaces confine both horizontally and vertically polarized signals propagating the structure therein reducing the leakage of signals propagating the structure.

5. The method according to claim 2, further comprising
providing one or more rows of fork-shaped pins at the transition region from the first RGW without the cantilever and the first RGW with the cantilever.

6. The method according to claim 5, wherein
the one or more rows of forked shaped pins comprise:
a first row of forked shaped pins disposed prior to the cantilever with their forks directed towards a leading edge of the cantilever; and
a second row of forked shaped pins disposed prior to the cantilever with their forks directed towards the leading edge of the cantilever.

7. The method according to claim 2, wherein
the actuator is a microelectromechanical systems (MEMS) actuator;
the upper structure is formed within a first silicon wafer;
the lower structure is formed within a second silicon wafer;
the MEMS actuator is monolithically integrated within at least one of the first silicon wafer and the second silicon wafer;
the cantilever is monolithically integrated within one of the first silicon wafer and the second silicon wafer.

8. The method according to claim 1, wherein
providing the variable power splitter comprises:
providing an input waveguide comprising a first “bed of nails” (BEONA) structure upon a first conductive plate and a second BEONA structure upon a second conductive plate where the first BEONA structure and second BEONA structure face one another with a predetermined separation between them;
providing a first output waveguide of a pair of output waveguides comprising a third BEONA structure upon a third conductive plate;
providing a second output waveguide of the pair of output waveguides comprising, a fourth BEONA structure upon a fourth conductive plate;
providing a splitting region comprising:
a first port coupled to the input waveguide;
a second port coupled to the first output waveguide;
a third port coupled to the second output waveguide;
a fifth BEONA structure;
a sixth BEONA structure; and
a conductive plate disposed between the fifth BEONA structure and the sixth BEONA structure; wherein
the third BEONA structure and fourth BEONA structure face another initially as they couple to the second port and third port of the splitting region;
a first portion of the microwave signal coupled to the input waveguide is coupled to the first output waveguide in dependence upon a position of the conductive plate relative to the fifth BEONA structure and the sixth BEONA structure; and
a second portion of the microwave signal coupled to the input waveguide is coupled to the second output waveguide in dependence upon a position of the conductive plate relative to the fifth BEONA structure and the sixth BEONA structure.

9. The method according to claim 8, wherein
the conductive plate is moveable to adjust its separation from each of the fifth BEONA structure and the sixth BEONA structure.

10. The method according to claim 8, wherein
the conductive plate is a fixed-free cantilever plate held at a predetermined position within the splitting region; and
the free end of the cantilever can be moved relative to the fixed end to adjust its separation from each of the fifth BEONA structure and the sixth BEONA structure.

11. The method according to claim 8, wherein
the conductive plate is disposed at a predetermined position within the splitting region;
the fifth BEONA structure comprises a first row of forked pins disposed immediately prior to the predetermined position with their forks towards the predetermined position; and
the sixth BEONA structure comprises a second row of forked pins disposed immediately after the predetermined position with their forks towards the predetermined position.

12. The method according to claim 8, wherein
the splitting region comprises one or more electromagnetic soft surface structures.

13. The method according to claim 8, further comprising
an actuator mechanically coupled to the conductive plate to adjust the position of the conductive plate relative to the fifth BEONA structure and the sixth BEONA structure; wherein
the actuator is a microelectromechanical systems (MEMS) actuator;
the first BEONA, one of the third BEONA and fourth BEONA, and one of the fifth BEONA and sixth BEONA are formed within a first silicon wafer;
the second BEONA, the other of the third BEONA and fourth BEONA, and the other of the fifth BEONA and sixth BEONA are formed within a second silicon wafer;
the MEMS actuator is monolithically integrated within at least one of the first silicon wafer and the second silicon wafer;
the cantilever is monolithically integrated within one of the first silicon wafer and the second silicon wafer.

14. A reconfigurable microwave device comprising:
a first ridge gap waveguide (RGW) comprising:
an upper structure comprising a periodic structure comprising a plurality of pins disposed on a solid conductor; and
a lower structure comprising a periodic structure comprising a plurality of pins disposed on a solid conductor; and
a cantilevered sheet disposed between the upper structure of the first RGW and the lower structure of the first RGW; wherein
the plurality of pins of the upper structure of the first RGW are disposed towards the plurality of pins of the lower structure of the first RGW;
the upper structure of the first RGW and the lower structure of the first RGW are disposed a predetermined distance apart; and
variation of gaps between the cantilevered sheet and each of the upper structure of the first RGW and the lower structure of the first RGW results in a variation of splitting microwave power guided within the first RGW to each of a second RGW comprising, the upper structure only and a third RGW comprising the lower structure only.

15. The reconfigurable microwave device according to claim 14, wherein
at least one of:
the cantilever is coupled to an actuator to adjust the gaps and the actuator is one of a mechanical actuator, an electromechanical actuator; and a microelectromechanical systems actuator; and
the cantilever is formed from an electrically conductive material or is formed from a non-conductive material with an electrically conductive outer coating.

16. The reconfigurable microwave device according to claim 14, wherein
at least one of:
the variation in splitting has a first limit with substantially no power in the second RGW and a second limit with substantially no power in the third RGW; and
the variation in splitting is continuous between a first limit with the second RGW and a second limit within the second RGW.

17. The reconfigurable microwave device according to claim 14, further comprising
one or more soft surfaces at the region with the cantilever; wherein
the one or more soft surfaces confine both horizontally and vertically polarized signals propagating the structure thereby reducing the leakage of signals propagating the structure.

18. The reconfigurable microwave device according to claim 14, further comprising
one or more rows of fork-shaped pins at the transition region from the first RGW without the cantilever and the first RGW with the cantilever.

19. The reconfigurable microwave device according to claim 18, wherein
the one or more rows of forked shaped pins comprises:
a first row of forked shaped pins disposed prior to the cantilever with their forks directed towards a leading edge of the cantilever; and
a second row of forked shaped pins disposed prior to the cantilever with their forks directed towards the leading edge of the cantilever.

20. A device for distributing a microwave signal from an input waveguide to a pair of output waveguides comprising:
the input waveguide comprising a first “bed of nails” (BEONA) structure upon a first conductive plate and a second BEONA structure upon a second conductive plate where the first BEONA structure and second BEONA structure face one another with a predetermined separation between them;
a first output waveguide of the pair of output waveguides comprising a third BEONA structure upon a third conductive plate;
a second output waveguide of the pair of output waveguides comprising a fourth BEONA structure upon a fourth conductive plate;
a splitting region comprising:
a first port coupled to the input waveguide;
a second port coupled to the first output waveguide;
a third port coupled to the second output waveguide;
a fifth BEONA structure;
a sixth BEONA structure; and
a conductive plate disposed between the fifth BEONA structure and the sixth BEONA structure; wherein
the third BEONA structure and fourth BEONA structure face another initially as they couple to the second port and third port of the splitting region;
a first portion of the microwave signal coupled to the input waveguide is coupled to the first output waveguide in dependence upon a position of the conductive plate relative to the fifth BEONA structure and the sixth BEONA structure; and
a second portion of the microwave signal coupled to the input waveguide is coupled to the second output waveguide in dependence upon a position of the conductive plate relative to the fifth BEONA structure and the sixth BEONA structure.

21. The device according to claim 20, wherein
the conductive plate is moveable to adjust its separation from each of the fifth BEONA structure and the sixth BEONA structure.

22. The device according to claim 20, wherein
the conductive plate is a fixed-free cantilever plate held at a predetermined position within the splitting region; and
the free end of the cantilever can be moved relative to the fixed end to adjust its separation from each of the fifth BEONA structure and the sixth BEONA structure.

23. The device according to claim 20, wherein
the conductive plate is disposed at a predetermined position within the splitting region;
the fifth BEONA structure comprises a first row of forked pins disposed immediately prior to the predetermined position with their forks towards the predetermined position; and
the sixth BEONA structure comprises a second row of forked pins disposed immediately after the predetermined position with their forks towards the predetermined position.

24. The device according to claim 20, wherein
the splitting region comprises one or more electromagnetic soft surface structures.
